(19) United States
(12) Patent Application Publication
(10) Pub. No.: US 2006/0198935 A1
(43) Pub. Date: Sep. 7, 2006

(54) Method of cooling alcoholic cocktails

(76) Inventors: James G. Boyko, Gorham, ME (US); John N. Stewart, Gorham, ME (US)

Correspondence Address: James Boyko, 27 Church St., Gorham, ME, 04038, US

(21) Appl. No.: 11/071,782

(22) Filed: Mar. 4, 2005

(51) Int. Cl. A23L 3/36

(52) U.S. Cl. 426/524

(57) ABSTRACT

A method is disclosed for cooling an alcoholic cocktail, consisting of the combining liquid nitrogen with the cocktail. The method is based on the high differential temperature between the liquid nitrogen and the cocktail, which provides for quick cooling and the capability of cooling the cocktail to its freezing point. The cooling process is enhanced by adding agitation to the mixture of the liquid nitrogen and the cocktail.

### BACKGROUND

1. Field of the Invention

This invention relates to the field of methods for cooling alcoholic cocktails.

2. Description of Prior Art

Alcoholic beverages date back to early civilization and have evolved through the ages to become an important part of our economy and culture. A currently fashionable alcohol beverage is termed a cocktail which is primarily constructed from alcoholic liquors such as gin, vodka or whiskey. Other ingredients such as vermouth and fruit juices are sometimes added for flavor. Examples of popular cocktails are the Martini (vodka or gin and vermouth for flavoring) and the Manhattan (whiskey with vermouth, bitters and cherry for flavoring).

Well-established recipes state that the cocktail should served as cold as possible in order to maximize its flavor. Two methods are applied today for cooling the cocktail, specifically:
a) Cooling is accomplished by inserting the cocktail in a freezer box. Unfortunately, heat transfer within the freezer box is very slow and therefore several hours may be required to sufficiently cool the cocktail. Also, the final temperature of the cocktail is limited to the temperature inside the freezer box, which is typically 0 F.
b) Cooling is accomplished by stirring or shaking the cocktail with ice. During this cooling process, the ice partially melts and thus dilutes the cocktail which diminishes its flavor qualities. In order to minimize this dilution effect, recipes typically require that the ice is strained from the cocktail prior to serving.

In summary, the conventional methods of cooling alcoholic cocktails are hampered by several disadvantages:
a) The method of inserting the cocktail in a conventional freezer box suffers from the slow transfer of heat from the cocktail to the freezer refrigeration system and therefore is very time-consuming. A preferred method would utilize direct contact between the cocktail and a cold medium and thereby achieve a fast transfer of heat and quick cooling.
b) The method of inserting the cocktail in a conventional freezer box limits the final temperature of the cocktail to approximately OF. A preferred method would allow the cocktail to be further cooled, ideally to the freezing point of cocktail which is approximately −30 F.
c) The method of agitating the cocktail with the addition of ice significantly dilutes the cocktail with water and thus diminishes its epicurean value. A preferred method would be to cool the cocktail via direct contact with a cold medium that is not water-based and thereby avoid dilution due to melted ice.

What is needed, therefore, is a method for quickly cooling a cocktail. What is further needed is a method that can cool a cocktail to its freezing point. What is yet further needed is a method of cooling a cocktail that will not dilute the cocktail with water.

### OBJECTS AND ADVANTAGES OF THE INVENTION

It is the object of the present invention to quickly cool alcoholic cocktails. It is further an object of the present invention to cool alcoholic cocktails to the freezing point of the alcoholic cocktail. It is yet further an object of the present invention to cool alcoholic cocktails without diluting the cocktail with water.

In order to achieve these objects, the present invention provides a means of evaporating liquid nitrogen (LN2) in direct contact with the cocktail prior to serving. The LN2 acts to quickly cool the cocktail for two reasons: (1) the heat-transfer process is promoted by the direct contact between the cocktail and the LN2 and (2) the heat-transfer process is promoted by the high temperature differential between the cocktail (nominal 70 F) and the evaporating LN2 (−320 F). Also, the cocktail can be readily cooled to its freezing point since the temperature of the evaporating LN2 is substantially lower than the freezing point of the cocktail (nominal −30 F). In addition, the cocktail is not diluted with water during the cooling process since the cooling process occurs without the melting of ice.

During the development of this invention, experiments have been performed to determine the parameters of the stated cooling process. These experiments have indicated that approximately 0.08 liter of LN2 is required to cool a typical 2 ounce, 90 proof (45% alcohol) cocktail to a temperature of −30 F. It is noted that the time required to complete the stated cooling process is approximately 3 seconds, which is substantially faster than prior art methods.

Also during the development of this invention, it has been observed that the stated cooling process can cool a cocktail to its freezing point, thus freezing a portion of the water component the cocktail and forming a viscous ice-slurry. This formation of an ice-slurry is deemed to be a desirable feature for several reasons:
a) The ice-slurry has been demonstrated to be highly pleasing to both the taste and sight.
b) The partial freezing of the cocktail allows the cocktail to sustain its cold temperature for a longer period of time, relative to a cocktail that has not been partially frozen.
c) The eventual melting of the ice does not dilute the cocktail since the water which formed the ice originates from the cocktail itself. As a result, the alcohol content of the cocktail after the ice has melted is identical to the alcohol content of the cocktail prior to the formation of ice.

Also during the development of this invention, it has been determined that the stated cooling process is economically viable. For example, 0.08 liters of LN2 is required to cool a typical 2 ounce, 90 proof cocktail from 70 F to −30 F. The cost of 0.08 liters of LN2 is $0.22 at 2005 prices, which represents a mere 6% cost addition for a cocktail with a typical retail cost of $4.00.

Also during the development of this invention, it has been verified that the stated cooling process is biologically safe and environmentally benign. It is noted that our atmosphere is comprised of 78% nitrogen. Therefore, the small amount of nitrogen emitted by the stated cooling process has no adverse affects on end-users or the environment.

In conclusion, the present invention accomplishes several important tasks:
a) The present invention provides a means to quickly cool a cocktail.
b) The present invention provides a means to cool a cocktail to its freezing point.
c) The present invention provides a means to cool a cocktail without diluting the cocktail with water.
d) The present invention provides a means to cool a cocktail into a pleasing ice-slurry.
e) The present invention provides a means to cool a cocktail that is economically viable.
f) The present invention provides a means to cool a cocktail that is safe for both the end-user and the environment.

### BRIEF DESCRIPTION OF THE DRAWINGS

FIG. 1 is a schematic drawing of the preferred embodiment of the present invention which utilizes typical devices and tools associated with cocktails and LN2.

FIG. 2 is a sequence-of-operations diagram of the preferred embodiment of the present invention.

### REFERENCE NUMERALS IN DRAWINGS

1 Blender
2 Cocktail
3 Storage vessel
4 LN2
5 Measuring vessel
6 Serving vessel

### DETAILED DESCRIPTION OF THE INVENTION

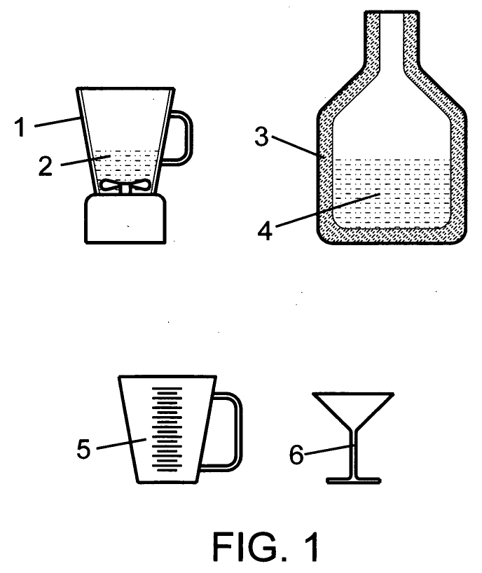

The objectives and advantages of the present invention are achieved by applying typical devices and tools associated with cocktails and LN2, illustrated by FIG. 1 and described as follows:

FIG. 1 shows a blender 1 consisting of a vessel with an internally mounted, motorized agitator. Blender 1 contains cocktail 2 prior to the cooling process. The purpose of blender 1 is to add agitation to the cocktail 2 during the cooling process, thus both promoting the cooling process and providing a homogeneous final product.

FIG. 1 also shows a storage vessel 3 for the purpose of storing a supply of LN2 4 prior to the cooling process. Storage vessel 3 is well-insulated in order to reduce the evaporation of LN2 4.

FIG. 1 also shows a measuring vessel 5 which contains the amount of LN2 4 required for the cooling process. Measuring vessel 5 is marked to allow the measurement of the amount of LN2 4 required to adequately complete the cooling process. Measuring vessel 5 is constructed of a material that will not be damaged by the ultra-low temperature of LN2 4, typically tempered glass or polyethylene plastic.

FIG. 1 also shows serving vessel 6 which contains the cocktail 2 after the cooling process is complete.

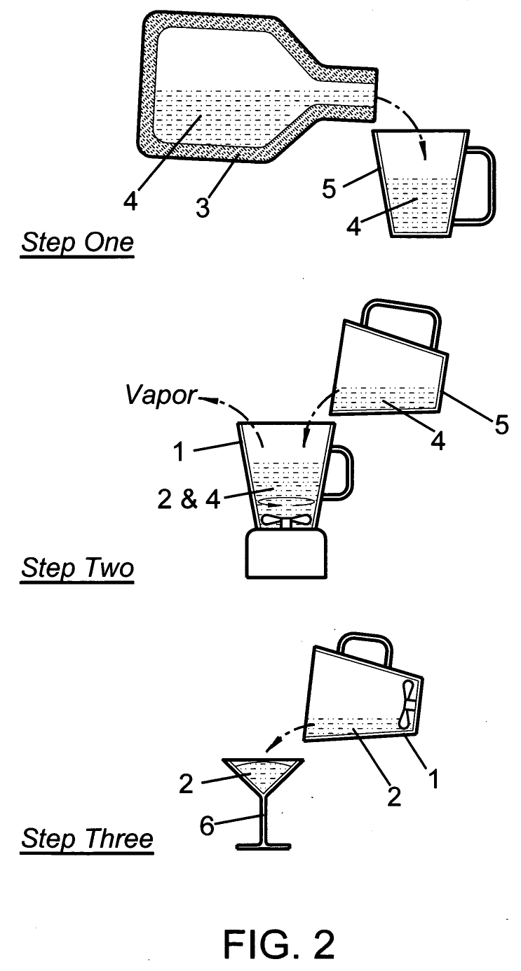

Now, referring to FIG. 2, the three-step process is explained as follows:

Step One—Transfer LN2 4 from Storage Vessel 3 to Measuring Vessel 5.

As illustrated by FIG. 2, LN2 4 is transferred from storage vessel 3 to measuring vessel 5. The amount of LN2 4 that is transferred is dependent on the desired cooling effect.

Step Two—Transfer LN2 4 from Measuring Vessel 5 to Blender 1.

As illustrated by FIG. 2, LN2 4 is transferred from measuring vessel 5 to blender 1 and thus combined with the cocktail 2. During this process, blender 1 is energized and thus agitation is applied to the resultant mixture of LN2 4 and cocktail 2. Also during this process, LN2 4 is transformed from a liquid state to a vapor state and subsequently flows from blender 1 to the atmosphere. During this transformation, heat is transferred from cocktail 2 to LN2 4 and subsequently the temperature of cocktail 2 is reduced. It is noted that temperature of cocktail 2 can be lowered to its freezing point, thus causing the portion of the water within cocktail 2 to partially change from a liquid to frozen state. At this point in the operation, cocktail 2 has been cooled to its desired state and LN2 4 has been completely removed from cocktail 2 through the process of evaporation.

Step Three—Transfer Cocktail 2 from Blender 1 to Serving Vessel 6.

As illustrated by FIG. 2, cocktail 2 is transferred from blender 1 to serving vessel 6. At this final point in the operation, cocktail 2 is ready for consumption.

It should be understood that the preferred embodiment is merely illustrative of the present invention. Numerous variations may be contemplated in view of the following claims without straying from the intended scope and field of the invention disclosed herein.

I claim:

1. A method for cooling an alcoholic cocktail, comprised of combining said alcoholic cocktail with liquid nitrogen so that said alcoholic cocktail is in direct contact with said liquid nitrogen.

2. The invention of claim 1, wherein said alcoholic cocktail is cooled to its freezing point.

3. The invention of claim 2, wherein agitation is applied to the mixture of said liquid nitrogen and said alcohol cocktail.
